(19) United States
(12) Patent Application Publication
(10) Pub. No.: US 2010/0157037 A1
(43) Pub. Date: Jun. 24, 2010

(54) ENDOSCOPE SYSTEM WITH SCANNING FUNCTION

(75) Inventors: Kohei IKETANI, Saitama (JP); Yoichi HITOKATA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/644,191

(22) Filed: Dec. 22, 2009

(30) Foreign Application Priority Data
Dec. 22, 2008 (JP) 2008-326277

(51) Int. Cl. H04N 7/18; H04N 5/225

(52) U.S. Cl. 348/68; 348/220.1; 348/E07.085; 348/E05.024

(57) ABSTRACT

An endoscope system has an optical fiber configured to transmit illumination light emitted from a light source to the tip portion of a scope; a scanner configured to spirally scan a target area with the illumination light by vibrating the tip portion of the optical fiber; and an image generator configured to generate an observation image from image-pixel signals that are obtained from light reflected off of the target area. The endoscope system further has a resolution adjuster that adjusts a resolution of the observation image in accordance to a photographic state by controlling at least one of either a movement (drive) of the fiber tip portion or a sampling of the image-pixel signals.

### BACKGROUND OF THE INVENTION

1. Field of the Invention

The present invention relates to endoscope system that scans illumination light over a target area, such as tissue. In particular, it relates to controlling a resolution of an observation image.

2. Description of the Related Art

An endoscope system with scanning functionality is equipped with a scanning fiber, such as a single mode type of fiber, which is provided in an endoscope. As described in U.S. Pat. No. 6,294,775 and U.S. Pat. No. 7,159,782, the tip portion of the scanning fiber is held by an actuator, such as a piezoelectric device, that vibrates the tip portion spirally by modulating and amplifying the amplitude (waveform) of the vibration. Consequently, illumination light, passing through the scanning fiber, is spirally scanned over an observation area.

Light reflected off the observation area enters into an image fiber and is transmitted to a processor via the image fiber. The transmitted light is transformed to image-pixel signals by photosensors. Then, each one of the image-pixel signals detected in time-sequence is associated with a scanning position. Thus, a pixel signal in each pixel is identified and image signals are generated. The spiral scanning is periodically carried out on the basis of a predetermined time-interval (frame rate), and one frame's worth of image pixel signals are successively read from the photosensors in accordance with the frame rate.

During scanning, the resolution of an observation image does not change because the number of sampled pixels in one frame interval (one spiral interval) is constant. Therefore, even if a significant amount of tissue exists in an observation area, an image with higher resolution cannot be displayed.

### SUMMARY OF THE INVENTION

An object of the present invention is to provide an endoscope system that is capable of generating a high quality image while scanning.

An endoscope system according to the present invention has an optical fiber configured to transmit illumination light emitted from a light source to the tip portion of a scope; a scanner configured to spirally scan a target area with the illumination light by vibrating the tip portion of the optical fiber; and an image generator configured to generate an observation image from image-pixel signals that are obtained from light reflected off of the target area.

The endoscope system further has a resolution adjuster that adjusts a resolution of the observation image in accordance to a photographic state by controlling at least one of either a movement (drive) of the fiber tip portion or a sampling of the image-pixel signals. Thus, a high-quality image of a tissue portion can be displayed. On the other hand, when motion occurs in an observation image due to a disturbance of the scope tip portion, an image captured with resolution sufficiently high for viewing can be displayed at a relatively high frame rate. Thus, motion in the observation image is smoothed out.

The movement is relatively easy to control, which allows the resolution to be modified freely. Also, it is preferable to enhance the resolution such that the density of scan lines in a radial direction is uniform over the entire scan area. Hence, the resolution adjuster may control the movement of the fiber tip portion so that the number of spiral scanning lines may be increased or decreased.

While the scope tip portion is moving inside of an organ, a high quality image is not necessary because blurring occurs in the image. Nevertheless, confirmation of a location captured by a scope is important for an operator. Therefore, the resolution adjuster may determine whether the photographic state is a still or moving state. The still or nonmoving state represents a condition in which a target area remains still as it is captured at close range. The moving state represents the condition in which the fiber tip portion either moves inside of an organ or is bended so that it moves closer to a capture area. It is preferable to enhance the resolution of the observation image in the nonmoving state compared to the moving state. During the moving state, a high-resolution image that requires extended time for processing image data is not displayed, instead an image having a resolution that is sufficiently high enough for confirming a target area is displayed.

To accurately distinguish between the moving state and the nonmoving state, the endoscope system must have a motion detector that detects for movements of the observation image, and a scope motion detector configured to detect for disturbances of the fiber tip portion. To distinguish a movement by an organ itself from the moving state, the resolution adjuster may determine the photographic state on the basis of both the motion of the observation image and the motion of the fiber tip portion.

Considering that an operator intends to display a high-resolution image, the endoscope system may have a mode-setting processor that sets a high-resolution mode. The resolution adjuster enhances the resolution when the high-resolution mode is set.

When the fiber tip portion is moving during a state in which a high-resolution image is displayed, it is not necessary to maintain the high-quality resolution. Therefore, during the high-resolution mode the resolution adjuster determines whether the photographic state is a still or moving state. The resolution adjuster may decrease the resolution in the moving state.

When driving the fiber tip portion at an excessive high speed, distortion may occur. Therefore, the resolution adjuster may lengthen the frame interval while maintaining a constant scan speed for the fiber tip portion. For example, the resolution adjuster may decrease a rate of increase in amplitudes of the fiber tip portion.

An apparatus for adjusting a resolution of an observation image, according to another aspect of the present invention, has a determiner that determines whether the photographic state is a still state or moving state when spirally scanning a target area with the illumination light; and a resolution adjuster that increase the number of spiral scan lines so as to enhance a resolution of an observation image when the photographic state is a still state.

A computer-readable medium that stores a program or adjusting a resolution of an observation image, according to another aspect of the present invention, has a determination code segment that determines whether the photographic state is a still state or moving state when spirally scanning a target area with the illumination light; and a resolution adjustment code segment that increase the number of spiral scan lines so as to enhance a resolution of an observation image when the photographic state is a still state.

A method for adjusting a resolution of an observation image, according to another aspect of the present invention, includes: a) determining whether the photographic state is a still state or moving state when spirally scanning a target area with the illumination light; and b) increasing the number of spiral scan lines so as to enhance a resolution of an observation image when the photographic state is a still state.

### BRIEF DESCRIPTION OF THE DRAWINGS

The present invention will be better understood from the description of the preferred embodiments set forth below, together with the accompanying drawings, in which:

FIG. 1 is a block diagram of an endoscope system according to a first embodiment;

FIG. 2 is an illustration of the scanning optical fiber, scanning unit, and spiral scan pattern

FIGS. 3A and 3B are schematic views of a scan area;

FIG. 4 is a timing chart of a fiber driving process;

FIG. 5 is a flowchart of a scan control process performed by the system controller; and

FIG. 6 is a flowchart of the scan control process according to the second embodiment.

### DESCRIPTION OF THE PREFERRED EMBODIMENTS

Hereinafter, the preferred embodiments of the present invention are described with reference to the accompanying drawings.

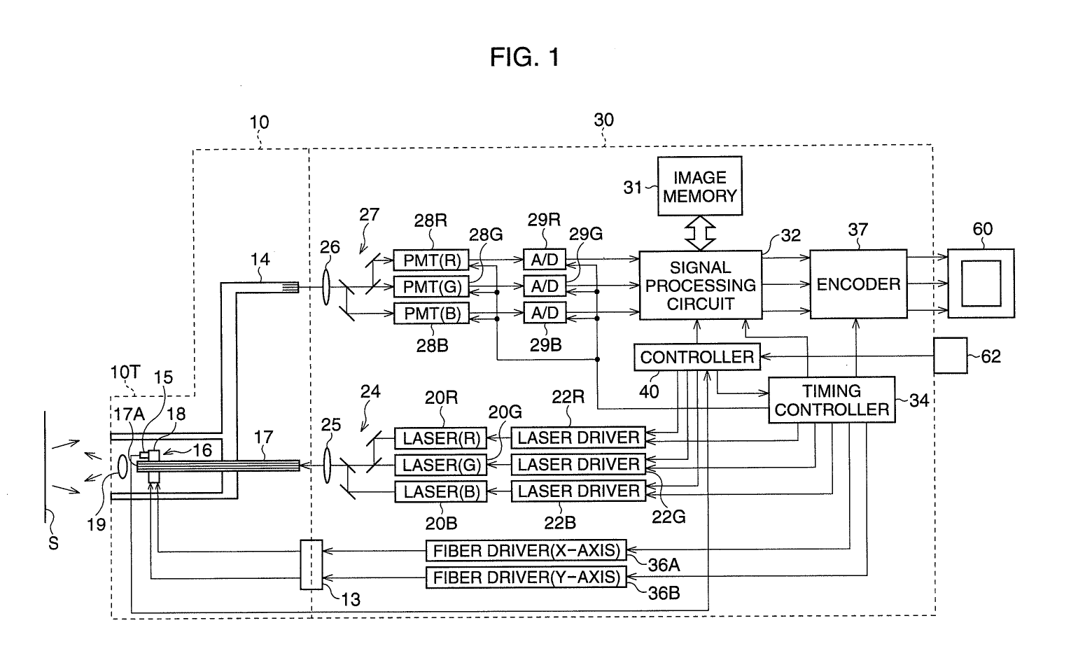

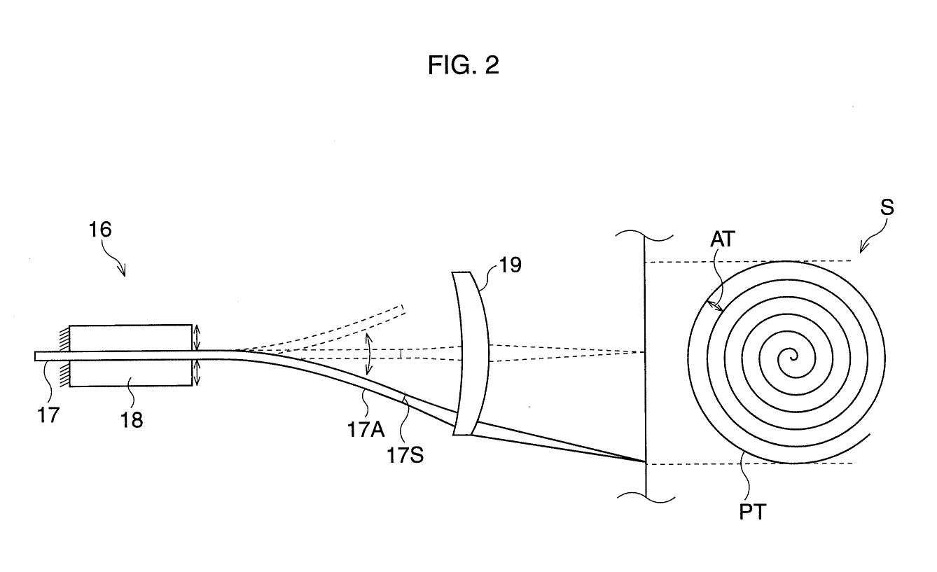

FIG. 1 is a block diagram of an endoscope system according to a first embodiment. FIG. 2 is an illustration of the scanning optical fiber, scanning unit, and spiral scan pattern.

The endoscope system is equipped with a processor 30 and an endoscope 10 that includes a scanning fiber 17 and an image fiber 14. The single mode type of scanning fiber 17 transmits illumination light, whereas the image fiber 14 transmits light that is reflected off an observation target S such as tissue. The endoscope 10 is detachably connected to the processor 30, and the monitor 60 is connected to the processor 30.

The processor 30 has three lasers 20R, 20G, and 20B, which emit red, green, and blue light, respectively. The lasers 20R, 20G, and 20B are driven by three laser drivers 22R, 22G, and 22B, respectively. The simultaneously emitted red, green, and blue light is collected by half-mirror sets 24 and a collection lens 25. Consequently, white light enters the scanning fiber 17 and travels to the tip portion 10T of the endoscope 10. The light exiting from the scanning fiber 17 illuminates the target S.

As shown in FIG. 2, a scanning unit 16 is provided in the scope tip portion 10T. The scanning unit 16 has a cylindrical actuator 18 and scans illumination light over the target S. The optical fiber 17 passes through the axis of the actuator 18. The fiber tip portion 17A, which cantilevers from the actuator 18, is supported or held by the actuator 18.

The actuator 18 fixed at the scope tip portion 10T is, herein, a piezoelectric tubular actuator that resonates the fiber tip portion 17A in two dimensions. Concretely speaking, a pair of piezoelectric devices in the actuator 18 vibrates the fiber tip portion 17A with respect to two axes (X-axis and Y-axis) that are perpendicular to one another, in accordance with a resonant mode. The vibration of the fiber tip portion 17A spirally displaces the position of the fiber end surface 17S from the axial direction of the optical fiber 17.

The light emitted from the end surface 17S of the scanning fiber 17 passes through an objective lens 19, and reaches the target S. A course traced by a scanning beam, i.e., a scan line PT, forms a spiral pattern (see FIG. 2). Since a spiral interval AT in a radial direction is tight, the total observation area S is illuminated by spirally scanned light.

Light reflected from the target S enters the image fiber 14 and is transmitted to the processor 30. When the reflected light exits from the image fiber 14, it is divided into R, G, and B light by an optical lens 26 and half-mirror sets 27. the separated R, G, and B light then continues on to photosensors 28R, 28G, 28B, respectively, which transform the R, G, and B light to image-pixel signals corresponding to colors “R”, “G”, and “B”. The mage-pixel signals are detected in accordance to a given sampling rate.

The generated analog image-pixel signals are converted to digital image-pixel signals by A/D converters 29R, 29G, and 29B and then fed into a signal processing circuit 32, in which a mapping process is carried out. The successively generated digital R, G, and B image-pixel signals are arrayed in accordance to the order of a spiral scanning pattern. In the mapping process, each of the digital R, G, and B image-pixel signals are associated with a corresponding scanning position, so that raster-arrayed image-pixel signals are formed. Consequently, the pixel position of each of the R, G, and B digital image-pixel signals is identified, in order, and one frame's worth of digital R, G, and B image-pixel signals are generated successively and temporarily stored in an image memory 31. As described below, in the mapping process, a part of image-pixel signals are selected or sampled to form the observation image, the reminding image-pixel signals are not used. An interval of sampled image-pixel signals are defined in each spiral scan line.

In the signal processing circuit 32, the generated two-dimensional image-pixel signals are subjected to various image-processing procedures, including a white balance process so that video signals are generated. The generated video signals are sent to the monitor 60 via an encoder 37, thus an observation image is displayed on the monitor 60.

A system controller 40, which includes a ROM unit, a RAM unit, and a CPU, controls the action of the video processor 30 and the videoscope 10 by outputting control signals to the signal processing circuit 32, the laser driver 22R, 22G, and 22B, etc. A control program is stored in the ROM unit. A timing controller 34 outputs synchronizing signals to fiber drivers 36A, 36B for driving the scanning unit 16 and the laser drivers 22R, 22G, and 22B to synchronize the vibration of the fiber tip portion 17A with the timing of the emission of light. Also, the timing controller 34 outputs clock pulse signals to the photosensors 28R, 28G, and 28B.

A high-resolution mode is set by operating a mode switch 62, which is provided on a front panel of the video processor 30. The high-resolution mode is appropriate when observing a diagnostic image, which includes tissue, in detail. When the observation mode is switched from normal to high-resolution mode by operation of the mode switch 62, the resolution of an observation image is adjusted by controlling a movement of the fiber tip portion 17A, as described below. An acceleration sensor 15, which is provided in the scope 10, detects a disturbance of the scope tip portion 10T.

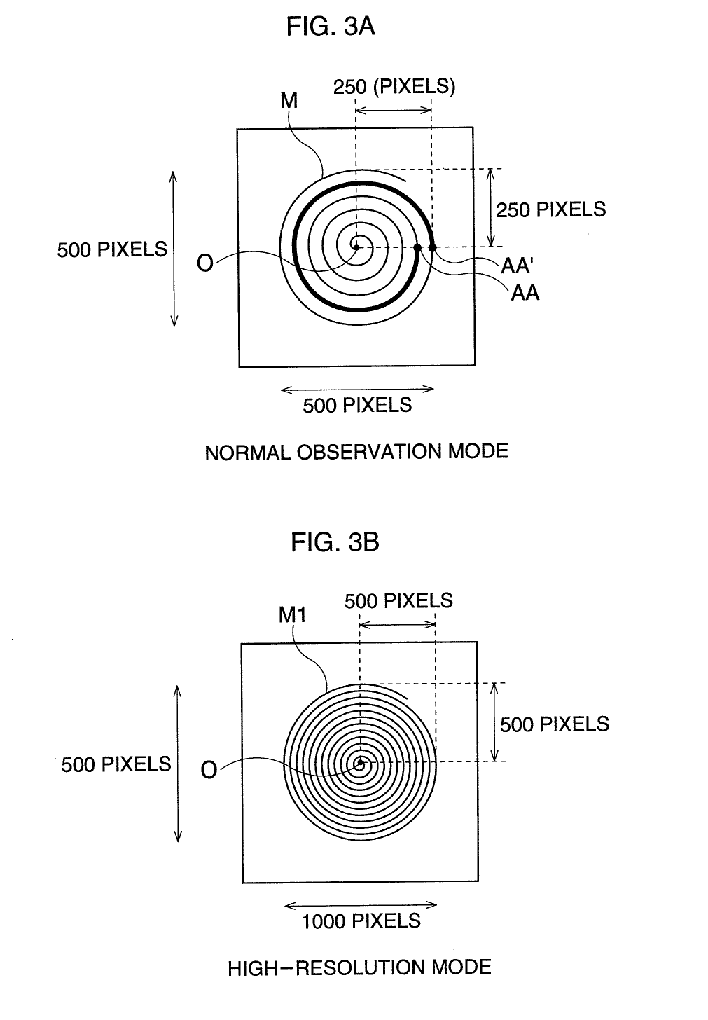

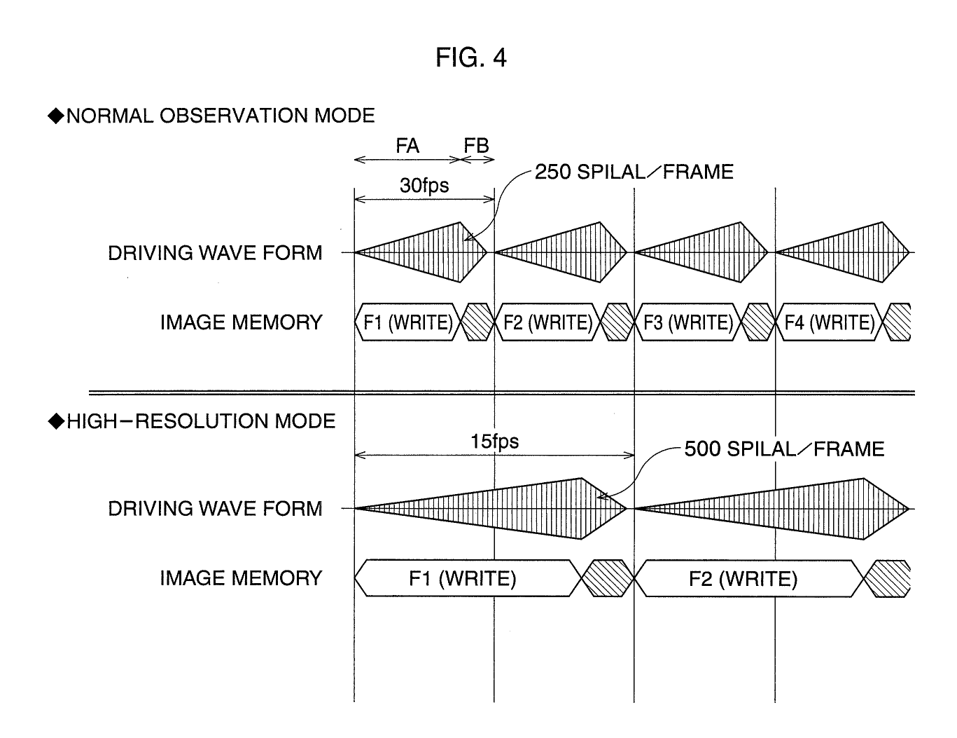

FIGS. 3A and 3B are schematic views of a scan area. FIG. 4 is a timing chart of a fiber driving process.

One frame's worth of a circular observation image M is formed by a spiral scan, and the number of scan lines in a radial direction depends upon the number of spiral revolutions. Note that a scanning section from one scan point on a given straight line to another scan point on the same straight line, where the two points are separated by one 360-degree spiral scanning revolution, is herein counted as “one scan line” (see one scan line from AA-AA′).

In the normal observation mode, an observation image M is displayed with the resolution of “500×500” pixels (dots). In other words, 250 pixels are arrayed from a center point “O”, which corresponds to a scan starting point, to a point on the exterior of the scanning pattern in the radial direction. Therefore, the number of spirals is 250.

During the normal observation mode, the movement of the fiber tip portion 17A is carried out so as to scan “250” spirals in one frame interval. Herein, one frame interval is set to 30 pfs. In FIG. 4, a driving waveform of the fiber tip portion 17A is shown. The spiral scan is carried out over an interval FA after scanning starts. In an interval FB, the fiber tip portion 17A returns to the center position corresponding to the scan starting point.

Image-pixel signals are generated in the photosensors 28R, 28G, and 28B at a predetermined sampling rate. Herein, the number of sampled pixels in each revolution (one spiral) is constant. For example, the number of samples is set to 2000/spiral. In the signal processing circuit 32, a portion of sampled image-pixel signals are utilized to form an observation image composed of 500×500 pixels, while the remaining pixels are not used. Many sampled (generated) image-pixel signals are abandoned in the spiral lines near the center position because the length of one revolution is relatively short, whereas most image-pixel signals in the exterior portion of the observation image are utilized. One frame's worth of image-pixel signals are successively stored in the image memory 31 at the frame rate (30 pfs).

When the high-resolution mode is set, the number of spirals is doubled, i.e., 500 spirals, without changing the entire scan area. Since the angular velocity of the fiber tip portion 17A is not changed, a rate of increase in the amplitudes of the driving waveform is reduced by a factor two, as shown in FIG. 4. Namely, the frame rate is changed to one-half times the frame rate of the normal observation mode (15 fps) while maintaining a constant angular velocity (scan velocity).

As a result, an observation image M1 formed in the high-resolution mode has the resolution of “1000×1000” pixels (see FIG. 3B). 500 pixels are arrayed from the center point O, in a radial direction. The density of pixels for the observation image M1 becomes two times that of the observation image M, and the number of pixels becomes four times as great.

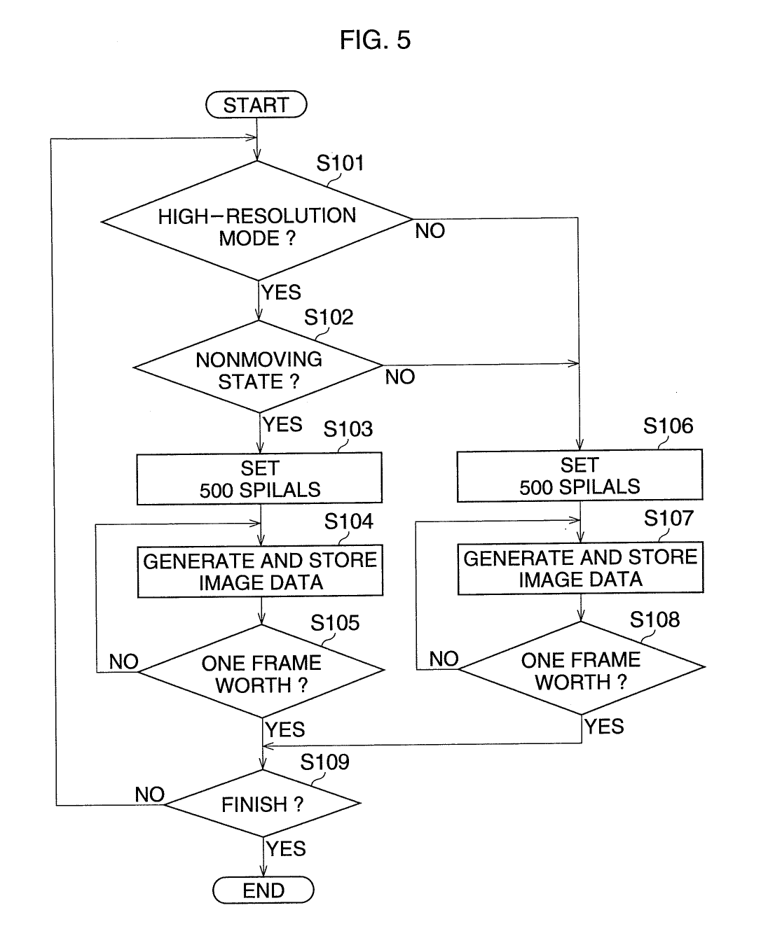

FIG. 5 is a flowchart of a scan control process performed by the system controller 40.

In Step S101, it is determined whether or not the high-resolution mode has been set by an operator. When the high-resolution mode is not set, a scanning process corresponding to the normal observation mode is carried out (S106). Namely, the frame rate is set to 30 fps and the fiber drivers 36A and 36B are controlled so as to carry out a 250-sprial scan.

Then, in accordance with a predetermined sampling rate, image-pixel signals are detected in time-sequence by the photosensors 28R, 28G, and 28B, and image-pixel data corresponding to 500×500 pixels (250 scan lines) are selected by the signal processing circuit 32 to generate one frame's worth of image data to be stored in the image memory 31 (S107). The image data are continuously written to the image memory 31 until one frame's worth of image data are stored (S108). When one frame's worth of image data are stored in the image memory 31, the process returns to Step S101.

On the other hand, when the high-resolution mode is set, it is determined whether or not a photographic state is in nonmoving state, a still-image for example (S102). Concretely, the acceleration sensor 15 detects the motion of the scope tip portion 10T, and the signal processing circuit 32 detects a motion vector from generated image data. The signal processing circuit 32 calculates difference data between generated image data in a present frame interval and image data generated in a previous frame interval, and stores the difference data in the image memory 31.

While an operator inserts the scope 10 in a body and moves the fiber tip portion 10T toward a target organ to be observed, a high-motion image is displayed on the monitor 60. It is not necessary to obtain a high-quality image during this condition. Conversely, since a new observation area is displayed continuously when the scope tip portion 10T moves, generating an observation image with a high frame rate is required.

On the other hand, when a motion vector is detected by difference data it cannot be clearly determined whether the scope tip portion 10T or the organ itself moved (e.g., a pulsation). Hence, in Step S102, when the motion of the scope tip portion 10T is detected and the motion vector is detected, it is decided that a photographic state is in a moving state.

When the photographic state is in the moving state, a spiral scan of 250 spirals is carried out, similarly to the normal observation mode (S106). On the other hand, when the photographic state is in the nonmoving state, a high-quality observation image is required to diagnose tissue in detail and the process proceeds to Step S103.

In Step S103, the fiber drivers 36A and 36B are controlled so as to carry out a 500-spiral scan while maintaining the same scan area. Furthermore, the frame rate is reduced by a factor of two, namely, to 15 fps. Image data corresponding to 500 spirals is stored in the image memory 31 (S104). The image data is continuously written to the image memory 31 until one frame's worth of image data are stored (S105). When one frame's worth of image data are stored in the image memory 31, the process returns to Step S101. Steps S101 to S108 are repeated until an observation is finished (S109).

In this way, in the present invention the scanning fiber 17 is provided in the scope 10 and the scanning unit 16 scans the illumination light two-dimensionally over the target area by vibrating the fiber tip portion 17A. Then, when the high-resolution mode is set and the photographic state is in the nonmoving state, the number of spirals is doubled and the frame rate is reduced by a factor of two. Thus, the high-quality observation image M1 is obtained. On the other hand, when the photographic state is a moving state during the high-resolution mode, scanning is carried out in the normal observation mode even though the high-resolution mode is set.

In a conventional endoscope system using an image sensor, the resolution of an image is restricted by the number of pixels defined by the image sensor. Therefore, even though the conventional endoscope system can decrease the resolution of an image by a reduced sampling, the resolution cannot be enhanced. On the other hand, the endoscope system according to the present embodiment can change the density of scan lines in a radial direction by controlling the movement of the fiber tip portion 17A. Furthermore, the endoscope system according to the present embodiment can switch between normal and high-resolution mode in each frame interval. Therefore, high-quality images can be rapidly displayed in a situation that requires high resolution. Also, since the scanning speed (angular velocity) is held constant as the frame rate is decreased, the high-quality image can be obtained without excessively high-speed movements of the fiber tip portion 17A.

Also, when movement occurs in the observation during the high-resolution mode, normal scanning is carried out. Thus, an observation image can be displayed that is sufficient for confirming both a target area and the location of the scope tip portion 10T. Furthermore, in the present embodiment, the nonmoving state is detected from two motions, namely, the motion of the scope tip portion 10T and the motion of the observation image. Thus, the normal spiral scan is not mistakenly carried out even if the target itself moves while in the high-resolution mode.

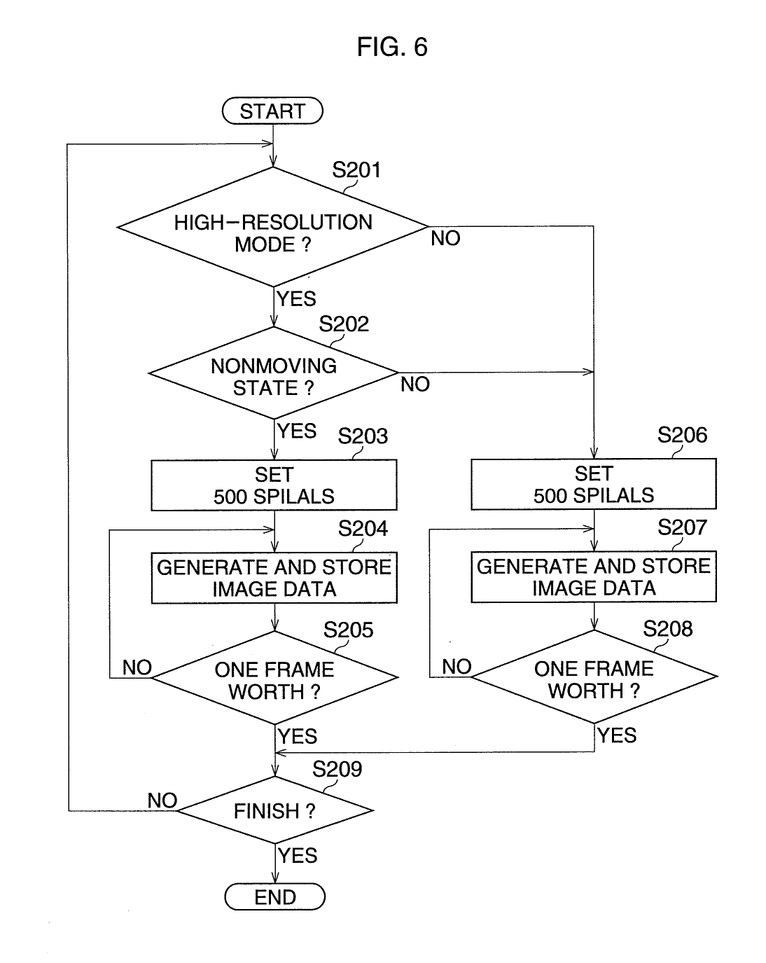

Next, the second embodiment is explained with reference to FIG. 6. The second embodiment is different from the first embodiment in that a sampling of image-pixel signals is adjusted when a change is made in resolution.

FIG. 6 is a flowchart of the scan control process according to the second embodiment.

The actions described in Steps S201 and 5202 are the same as those of Steps S101 and S102 shown in FIG. 5. In Step S206, the fiber drivers 36A and 36B are controlled so as to carry out a normal spiral scan that is similar to Step S106 in FIG. 5. On the other hand, in Step S203, the number of sampled pixels in each scan line (one revolution) is increased. For example, the sampled pixels are set to 4000 pixels/spiral. Then, pixels for constituting an image are selected from the generated image-pixel signals, such that an observation image composed of “1000×1000” pixels is displayed.

The high-resolution mode may be automatically set in accordance to a change in the photographic state, without the operation of the switch. Also, when either a motion vector or a motion of the fiber tip portion is detected during the high-resolution mode, the number of spirals may be changed to the number of spirals in the normal observation mode.

The resolution may be optionally defined by changing a sampling rate or the number of spirals. Also, the movements of the fiber tip portion may be increased to a speed that is higher than that of the normal observation, while maintaining the same frame rate. Furthermore, both the number of spirals and the sampling rate may be changed in the high-resolution mode

Note that a spiral scanning method other than the vibration of the fiber tip portion may be applied. For example, optical lens may be driven so as to scan spirally.

The present disclosure relates to subject matter contained in Japanese Patent Application No. 2008-326277 (filed on Dec. 22, 2008), which is expressly incorporated herein, by reference, in its entirety.

1. An endoscope system comprising:
an optical fiber configured to transmit illumination light emitted from a light source to the tip portion of a scope;
a scanner configured to spirally scan a target area with the illumination light by vibrating the tip portion of said optical fiber;
an image generator configured to generate observation image from image-pixel signals that are obtained by light reflected from the target area; and
a resolution adjuster that adjusts a resolution of the observation image in accordance to a photographic state by controlling at least one of a movement of the fiber tip portion and a sampling of the image-pixel signals.

2. The endoscope system of claim 1, wherein said resolution adjuster determines whether the photographic state is a still state or moving state, said resolution adjuster enhancing the resolution of the observation image in the nonmoving state compared to that in the moving state.

3. The endoscope system of claim 1, further comprising:
a motion detector that detects movement of the observation image; and
a scope motion detector configured to detect a motion of the fiber tip portion, said resolution adjuster determining the photographic state on the basis of both the motion of the observation image and the motion of the fiber tip portion.

4. The endoscope system of claim 1, further comprising a mode setting processor that sets a high-resolution mode, said resolution adjuster enhancing the resolution when the high-resolution mode is set.

5. The endoscope system of claim 4, wherein said resolution adjuster determines whether the photographic state is in a still state or moving state during the high-resolution mode, said resolution adjuster decreasing the resolution when the photographic state is in the moving state.

6. The endoscope system of claim 1, wherein said resolution adjuster controls the movement of the fiber tip portion so as to increase or decrease the number of spiral scan lines.

7. The endoscope system of claim 6, wherein said resolution adjuster lengthens the frame interval while maintaining the scanning speed of the fiber tip portion at a constant velocity.

8. An apparatus for adjusting a resolution of an observation image, comprising:
a determiner that determines whether the photographic state is a still state or moving state when spirally scanning a target area with the illumination light; and
a resolution adjuster that increase the number of spiral scan lines so as to enhance a resolution of an observation image when the photographic state is a still state.

9. A computer-readable medium that stores a program or adjusting a resolution of an observation image, comprising:
a determination code segment that determines whether the photographic state is a still state or moving state when spirally scanning a target area with the illumination light; and
a resolution adjustment code segment that increase the number of spiral scan lines so as to enhance a resolution of an observation image when the photographic state is a still state.

10. A method for adjusting a resolution of an observation image, comprising:
determining whether the photographic state is a still state or moving state when spirally scanning a target area with the illumination light; and
increasing the number of spiral scan lines so as to enhance a resolution of an observation image when the photographic state is a still state.
